(19) United States
(12) Patent Application Publication
(10) Pub. No.: US 2009/0245058 A1
(43) Pub. Date: Oct. 1, 2009

(54) INFORMATION PROCESSING APPARATUS AND METHOD, PROGRAM, RECORDING MEDIUM, AND INFORMATION PROCESSING SYSTEM

(75) Inventors: Makoto GOTO, Kanagawa (JP); Tatsuya INOKUCHI, Tokyo (JP); Takahisa OHGAMI, Tokyo (JP); Masanori KASA, Kanagawa (JP); Satoru KANDA, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 12/367,836

(22) Filed: Feb. 9, 2009

(30) Foreign Application Priority Data
Mar. 28, 2008 (JP) 2008-087605

(51) Int. Cl. G11B 7/00

(52) U.S. Cl. 369/53.44; G9B/7

(57) ABSTRACT

An information processing apparatus includes a measuring unit, a transmitter, and a receiver. The measuring unit first measures the performance of the information processing apparatus. The transmitter then transmits measurement results in the form of information indicating the performance measured by the measuring unit, together with a content request requesting desired content, to another information processing apparatus. The receiver subsequently receives content from the other information processing apparatus that has been supplied according to the content request and selected on the basis of the measurement results. In so doing, the information processing load is suitably adjusted according to the performance of the information processing apparatus.

### BACKGROUND OF THE INVENTION

1. Field of the Invention

The present invention relates to an information processing apparatus and method, program, recording medium, and information processing system. More particularly, the present invention relates to an information processing apparatus and method, program, recording medium, and information processing system able to suitably adjust the information processing load according to processing performance.

2. Description of the Related Art

In the BD-ROM (Blu-ray Disc Read-Only Memory) specification of the related art, there is defined a function for downloading content over a network (hereinafter referred to as BD-Live™ (Blu-ray Disc Live)) An optical disc playback device for playing back content recorded on a BD-ROM or other medium (hereinafter referred to as a BD (Blu-ray Disc) player) is able to make use of the BD-Live function by executing a title that has been authored using a BD-J™ (Blu-ray Disc Java) program. (In other words, the authored title is a software package that includes various types of data, such as content data and programs. Hereinafter, such titles will be referred to as BD-J titles.)

The BD specification also includes a “Virtual Package” function, whereby original content stored on packaged media is read and played back simultaneously with additional content that has been downloaded and stored on a recording medium. As a result, the BD player gives the appearance of playing back an up-to-date, virtual BD-ROM medium. In addition to downloading additional content, the Virtual Package function also includes functions for managing additional content as well as modifying GUI menus according to content updates. Since features such as GUI (Graphical User Interface) menus are executed as a part of particular application software, the downloading of content may thus involve altering the application software code. In this way, a BD player is able to use Java™-based BD-J applications to both download additional content and accommodate a wide variety of services.

BD-J is based on the Packaged Media profile of GEM™ (Globally Executable Multimedia Home Platform), an application standard for digital television that is itself based on Java™ technology. By reading and then executing a BD-J application (i.e., a Java™ program) included in a BD-J title that has been recorded on a BD-ROM, for example, a BD player creates content in an appropriate state by using the data recorded on the BD-ROM as well as externally-acquired data, and subsequently provides (i.e., plays back) that content.

In other words, by utilizing the above BD-Live function, the content holder that provides a particular BD-J title is able to keep the content included in that BD-J title up-to-date, even after a user has purchased the BD-ROM media. A BD player that plays back the BD-J title is thus able to, for example, download additional content such as the latest trailer clips, subtitle data for new languages, special footage, and games from a server (i.e., a Web site) provided by the content holder, and subsequently store such content on a recording medium such as an HDD (Hard Disk Drive) or flash memory.

An example of such a system is illustrated in FIG. 1. In FIG. 1, an optical disc playback device 11 includes both a drive for playing back content recorded onto an optical disc 21, as well as a memory unit 22. When the optical disc playback device 11 executes a BD-J title, a screen such as the menu screen 51 is displayed on the monitor 14 as a result of control by the BD-J application (i.e., the Java™ program). In addition, the BD-Live function is used, and additional content is downloaded from a server 31 of the content provider 13 via the Internet 12, and subsequently saved to the memory unit 22. Furthermore, by means of the Virtual Package function, the above additional content is combined with the content stored on the BD-ROM and then played back as virtual media.

In the example shown in FIG. 1, a new game program 41 is downloaded from the server 31 and then saved to the memory unit 22. Subsequently, information about the new game is displayed as “New Game 2” on the menu screen 51 that shows a list of items in the “Special Menu”. As a result of the user selecting “New Game 2” on the menu screen 51, the new game program 41 stored in the memory unit 22 is executed, and images of the new game content is displayed in the screen region 52 displayed on the monitor 14.

### SUMMARY OF THE INVENTION

However, BD players differ widely in performance. For example, while devices such as personal computers and high-end game consoles capable of BD-ROM playback often have high computational ability and graphics processing power, devices manufactured as inexpensive consumer electronic devices created exclusively for BD-ROM playback are often designed with the minimum acceptable level of performance in order to reduce manufacturing costs.

Given such variation in device performance across different equipment, there may be cases wherein, for example, the performance of a particular BD player is insufficient with respect to the amount of processing involved in executing an additional program acquired with the use of the BD-Live function. As a result, features such as the display of menu screens or the response times of BD-J titles may become unacceptably slow for normal operation. In some cases, a processing overflow may also occur, causing the title to freeze or lock up.

The present invention, being designed in light of the foregoing problems, enables the information processing load executed on a BD player to be suitably adjusted according to the performance of the BD player, wherein additional programs to be downloaded by means of the BD-Live function are selected according to the performance of the BD player.

An information processing apparatus in accordance with an embodiment of the present invention is provided with: measuring means for measuring the performance of the information processing apparatus; transmitting means for transmitting measurement results in the form of information indicating the performance measured by the measuring means, together with a content request requesting desired content, to another information processing apparatus; and receiving means for receiving content supplied by the other information processing apparatus according to the content request and selected on the basis of the measurement results.

The measuring means may measure apparatus performance by executing a predetermined benchmark test program.

The information processing apparatus may be further provided with control program executing means for executing a control program, wherein the measuring means measures apparatus performance, the transmitting means transmits the measurement results and the content request, and the receiving means receives the content by respectively following the control program executed by the control program executing means.

The control program may be stored on a storage medium that can be removably inserted into the information processing apparatus. The information processing apparatus may be further provided with reading means for reading the control program from the storage medium, wherein the control program executing means executes the control program that has been read from the storage medium by the reading means.

The information processing apparatus may be further provided with content executing means for executing content that has been received by the receiving means.

The information processing apparatus may be further provided with content selecting means for selecting content to acquire on the basis of the measurement results obtained as a result of measurement conducted by the measuring means. The transmitting means may then transmit to the other information processing apparatus a content request requesting the content that has been selected by the content selecting means.

An information processing method in accordance with another embodiment of the present invention includes the steps of: measuring the performance of an information processing apparatus; transmitting measurement results in the form of information indicating the performance measured by the measuring means, together with a content request requesting desired content, to another information processing apparatus; and receiving content supplied by the other information processing apparatus according to the content request and selected on the basis of the measurement results.

A program in accordance with another embodiment of the present invention causes a computer for processing information to function as: measuring means for measuring the performance of the computer; transmitting means for transmitting measurement results in the form of information indicating the performance measured by the measuring means, together with a content request requesting desired content, to another computer; and receiving means for receiving content supplied by the other computer according to the content request and selected on the basis of the measurement results.

A computer-readable recording medium in accordance with another embodiment of the present invention has recorded thereon a program that causes a computer to function as: measuring means for measuring the performance of the computer; transmitting means for transmitting measurement results in the form of information indicating the performance measured by the measuring means, together with a content request requesting desired content, to another computer; and receiving means for receiving content supplied by the other computer according to the content request and selected on the basis of the measurement results.

An information processing system in accordance with another embodiment of the present invention is an information processing system wherein a server provides content to an information processing apparatus. The information processing apparatus includes: measuring means for measuring the performance of the information processing apparatus; first transmitting means for transmitting measurement results in the form of information indicating the performance measured by the measuring means, together with a content request requesting desired content, to the server; and first receiving means for receiving content supplied by the server according to the content request and selected on the basis of the measurement results. The server includes: second receiving means for receiving the content request and the measurement results supplied by the information processing apparatus; selecting means for selecting content on the basis of the content request and the measurement results received by the second receiving means, whereby the selected content satisfies the request specified in the content request, and in addition, is suitable with respect to the performance of the information processing apparatus; and second transmitting means for transmitting the content selected by the selecting means to the information processing apparatus.

In an embodiment of the present invention, the performance of an information processing apparatus is measured, and measurement results in the form of information indicating the measured performance are then transmitted to another information processing apparatus, together with a content request requesting desired content. Content that has been supplied by the other information processing apparatus according to the content request and selected on the basis of the measurement results is then received.

In another embodiment of the present invention, the performance of an information processing apparatus is first measured, and then measurement results in the form of information indicating the measured performance are transmitted from the information processing apparatus to a server, together with a content request requesting desired content. The information processing apparatus then receives content supplied by the server according to the content request and selected on the basis of the measurement results. Meanwhile, the server receives the content request and the measurement results supplied by the information processing apparatus, and then selects content on the basis of the received content request and measurement results, whereby the selected content satisfies the request specified in the content request, and in addition, is suitable with respect to the performance of the information processing apparatus. The server then transmits the selected content to the information processing apparatus.

According to an embodiment of the present invention, programs can be downloaded to an information processing apparatus. More particularly, by downloading programs that match the performance of the information processing apparatus, the information processing load thereon can be suitably adjusted according to apparatus performance.

### BRIEF DESCRIPTION OF THE DRAWINGS

FIG. 1 illustrates an example of downloading content in accordance with the related art;

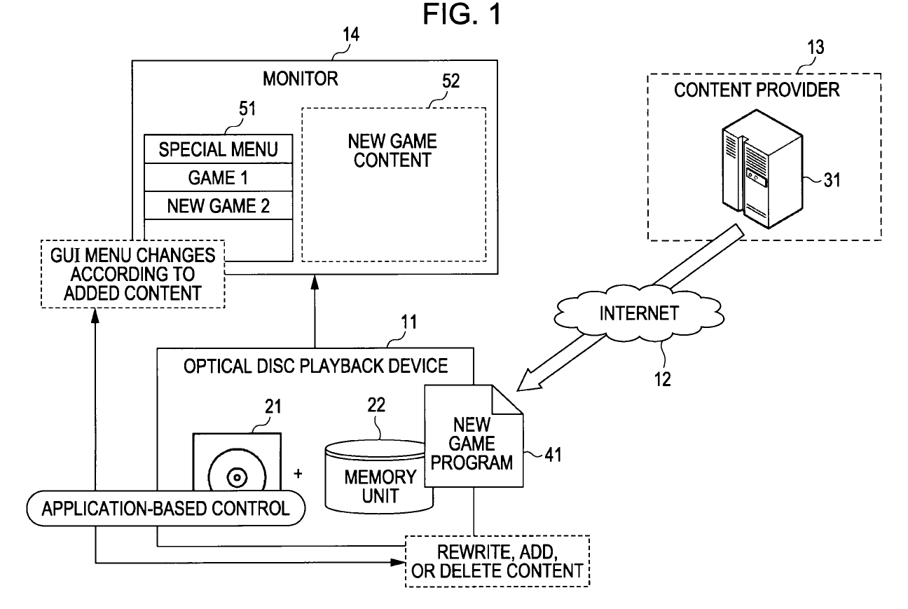

FIG. 2 is a block diagram illustrating an exemplary general configuration of a network system to which an embodiment of the present invention has been applied;

FIG. 3 illustrates an exemplary configuration of the optical disc playback device and optical disc shown in FIG. 2;

FIG. 4 illustrates an exemplary configuration of the server shown in FIG. 2;

FIG. 5 is a flowchart illustrating an exemplary control program;

FIG. 6 is a flowchart explaining an exemplary control process flow;

FIG. 7 is a flowchart explaining an exemplary content provision process flow;

FIG. 8 is a diagram explaining an example of content execution based on performance level;

FIG. 9 is a flowchart illustrating another exemplary control program;

FIG. 10 is a flowchart explaining another exemplary control process flow; and

FIG. 11 is a flowchart explaining another exemplary content provision process flow.

### DESCRIPTION OF THE PREFERRED EMBODIMENTS

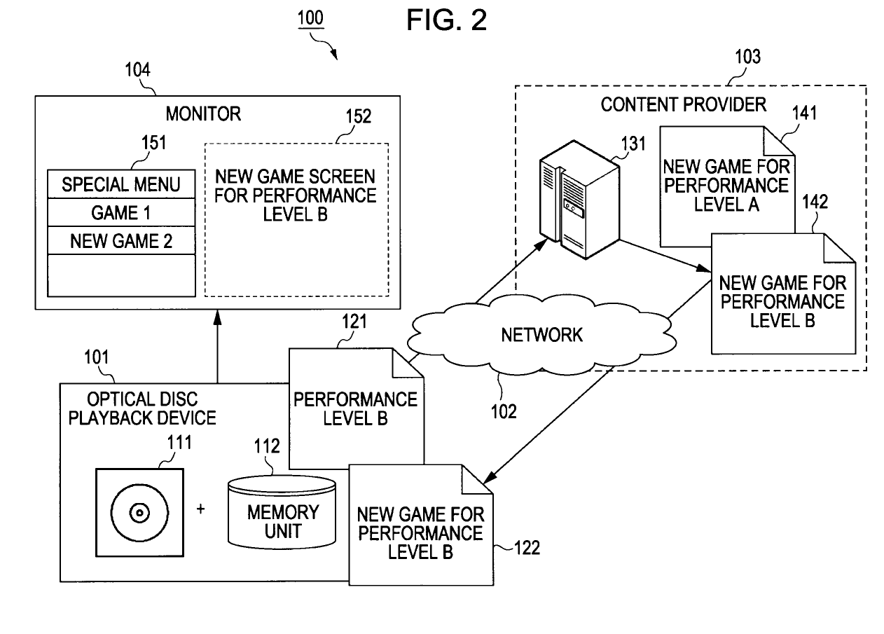

FIG. 2 is a block diagram illustrating an exemplary general configuration of a network system to which the present invention has been applied. In the network system 100 shown in FIG. 2, an optical disc playback device 101 acting as a BD player plays back BD-J titles making use of the BD-Live function. As shown in FIG. 2, the network system 100 includes an optical disc playback device 101 and an optical disc 111 connected to the server 131 of a content provider 103 via a network 102 typified by the Internet, as well as a monitor 104 that displays images from a BD-J title played back from the optical disc 111.

The optical disc playback device 101 includes a drive capable of playing back a BD-J title that has been recorded onto the optical disc 111, and a memory unit 112 realized by means of a storage medium such as a hard disk or flash memory. Included in the BD-J title recorded onto the optical disc 111 is a Java™-based control program, to be hereinafter described. The control program is executed when the optical disc playback device 101 executes the BD-J title. Following the control program, the optical disc playback device 101 then executes a benchmark test program recorded upon the optical disc 111, thereby measuring the performance of the optical disc playback device 101 itself.

Following the control program, the optical disc playback device 101 then issues a request for an additional program using the measurement results 121. In other words, the optical disc playback device 101 supplies the measurement results 121 indicating the performance of the device itself together with a request for an additional program to the server 131 via the network 102.

In the example shown in FIG. 2, the server 131 has been prepared in advance with two versions of an additional program. More specifically, the additional program is a new game program having a performance level A version and a performance level B version. The new game 141 for performance level A involves a heavy processing load when executed. If a device that does not exhibit performance level A executes the new game 141, problems such as delays in image display and user input response occur. The new game 142 for performance level B involves a lighter processing load when executed as compared to the new game 141 for performance level A. Thus, the new game 142 can be suitably executed without delays in image display or user input response or similar problems, even when executed on a device that exhibits the lesser performance level B rather than A.

The new game 141 for performance level A and the new game 142 for performance level B herein are programs with identical game content, but wherein the magnitude of the processing load upon execution has been made to differ between the two programs as a result of differences in features such as image quality and the amount of video processing involved. For example, the resolution of images in the new game 142 for performance level B may be reduced to less than that of images in the new game 141 for performance level A, and portions of the game expressed by video footage in the new game 141 for performance level A may be expressed by still images in the new game 142 for performance level B. In so doing, the load during execution (i.e., the amount of processing) is made to differ between the two programs. It should be appreciated that the above games may also differ in other ways, such as one game having particular scenarios or user choices omitted therefrom, both games having mutually different content in certain portions, or being different games altogether.

According to the measurement results 121 supplied from the optical disc playback device 101 in the present example, the performance level of the optical disc playback device is the less-powerful level B, and thus the server 131 supplies the new game 142 for performance level B having a lighter processing load to the optical disc playback device as a response to the request for an additional program.

The optical disc playback device 101 subsequently stores the new game 142 received above as the content 122 in the memory unit 112. Still executing the control program, the optical disc playback device 101 then combines the content 122 with the content recorded on the optical disc and plays back the combined content as a single set of content, thereby causing images thereof to be displayed on the monitor 104. As shown by way of example in FIG. 2, the optical disc playback device 101 may add “New Game 2” to the menu screen 151 as information indicating the availability of the new game 142 for performance level B, and thereby enabling the user to select the content 122. If the user subsequently selects “New Game 2”, then the optical disc playback device 101 executes the content 122 (i.e., the new game 142 for performance level B) in accordance with the selection, thereby causing a new game screen 152 for performance level B to be displayed on the monitor 104 and enabling the user to play the new game.

At this point, since the load (i.e., the amount of processing) during execution of the new game 142 for performance level B has been adjusted for performance level B, the new game can be executed without problems such as delays in image display and user input response occurring, even when executed by an optical disc playback device 101 of performance level B.

Thus, as a result of executing a control program as described above when downloading additional programs, the optical disc playback device 101 is able to download a program involving an amount of processing commensurate with the performance of the device itself. In other words, the above control program causes the device upon which the program is being executed to measure its own performance, thereby enabling the device to download, from a server, a program that involves an amount of processing suited to the performance of that device.

In contrast, it is also conceivable for the optical disc playback device 101 to download the new game 141 for performance level A from the server 131 and then execute the new game 141 while adjusting the load (i.e., the amount of processing) thereof to avoid lag or freezing, such as by selectively skipping certain images or processes. However, the data size for the more process-intensive new game 141 for performance level A is typically greater than that of the new game 142 for performance level B. Consequently, when downloading the new game 141 for performance level A, the optical disc playback device 101 downloads a program of unnecessarily large data size. As a result, the processing load is unnecessarily increased compared to the case wherein the program to be downloaded is selected as described earlier. In other words, the configuration described earlier enables more suitable adjustment of information processing load according to device performance.

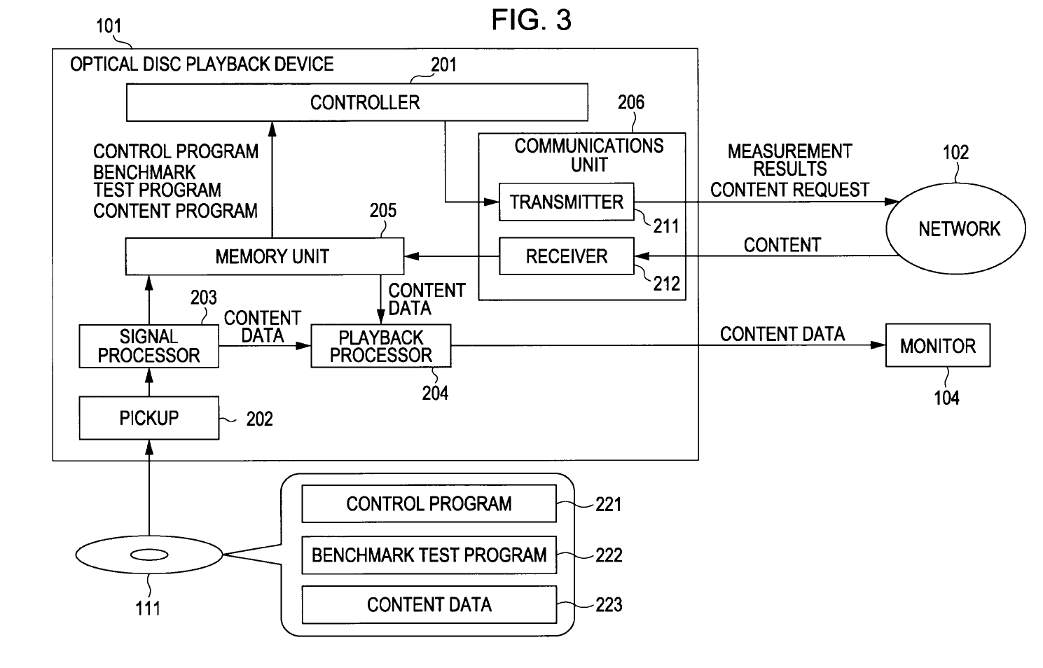

The respective components of the network system 100 will now be described in detail. FIG. 3 illustrates an exemplary detailed configuration of the optical disc playback device 101 and the optical disc 111.

In FIG. 3, the optical disc playback device 101 includes a controller 201, a pickup 202, a signal processor 203, a playback processor 204, a memory unit 205, and a communications unit 206.

The controller 201 is realized by means of components such as a CPU (Central Processing Unit), ROM (Read-Only Memory), and RAM (Random Access Memory). The controller 201 controls the respective components of the optical disc playback device 101, while additionally executing various programs, such as control programs read from the optical disc 111 or the memory unit 205, benchmark test programs, and content programs. Furthermore, the controller 201 also supplies the measurement results indicating the performance of the optical disc playback device 101 obtained by executing a benchmark test program to the transmitter 211 of the communications unit 206, together with an additional program request.

The pickup 202 reads data (including programs) from an optical disc 111 that has been loaded into the optical disc playback device 101 in a certain position, and subsequently supplies the read data to the signal processor 203. The signal processor 203 then performs demodulation and similar signal processing with respect to the data supplied by the pickup 202. If the data read from the optical disc 111 is a control program, a benchmark test program, or a content program such as a video game wherein a program is presented as content, then the signal processor 203 supplies the program data to the controller 201 via the memory unit 205, for example. The signal processor 203 may also be configured to supply such programs directly to the controller 201 without involving the memory unit 205. Meanwhile, if the data read from the optical disc 111 is content data such as video footage, for example, then the signal processor 203 supplies the content data to the playback processor 204.

The playback processor 204 takes video, audio, or other content data acquired from the signal processor 203 or the memory unit 205, and then subjects the content data to playback processing such as decoding processing and image quality (or audio quality) adjustment, for example. The playback processor 204 then supplies the processed content to the monitor 104 and causes the content to be output (i.e., displayed, in the case of video) thereon.

The memory unit 205 includes a storage medium such as RAM, flash memory or similar semiconductor memory, or a hard disk. The memory unit 205 stores data (including programs) that has been supplied from the signal processor 203 or the receiver 212 of the communications unit 206. In addition, the memory unit 205 also supplies stored data (including programs) to the controller 201 or the playback processor 204 as appropriate.

The communications unit 206 is an interface for connecting to the network 102 according to a particular standard such as Ethernet™, USB (Universal Serial Bus), or IEEE 1394 (Institute of Electrical and Electronics Engineers 1394), for example. The communications unit 206 includes a transmitter 211 and a receiver 212. The transmitter 211 transmits data such as measurement results and content requests supplied from the controller 201 to the server 131 via the network 102. The receiver 212 receives content (i.e., data or programs) supplied from the server 131 via the network 102, and then supplies such received content to the memory unit 205. It should be appreciated that the communications unit 206 may be a wired communications unit conducting wired communication, or a wireless communications unit conducting wireless communication.

The optical disc 111 is a storage medium that can be removably inserted into the optical disc playback device 101. As shown in FIG. 3, the optical disc 111 may store various data, such as a control program 221, a benchmark test program 222, and content data 223 that collectively constitute a BD-J title. It should be appreciated that although the content data 223 herein is referred to as data, “data” is herein defined as encompassing both programs and data. In other words, the content data 223 may refer to either or both of the content programs and the content data that are read by the optical disc playback device 101.

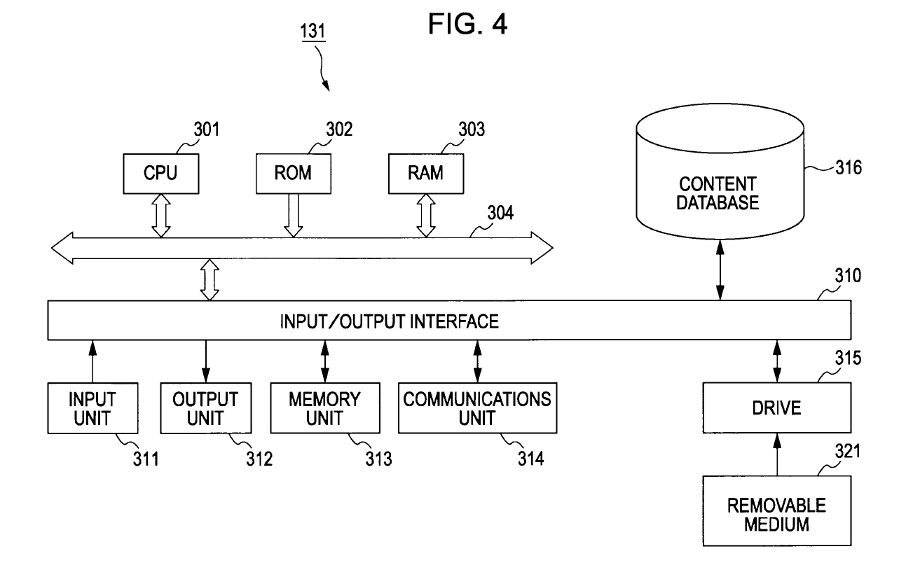

FIG. 4 is a block diagram illustrating an exemplary detailed configuration of the server 131 shown in FIG. 2. In FIG. 4, the CPU 301 of the server 131 executes various processing by following a program stored in the ROM 302 or a program that has been loaded into the RAM 303 from the memory unit 313. The RAM 303 also stores other information as appropriate, such as data involved in the execution of the various processing conducted by the CPU 301.

The CPU 301, the ROM 302, and the RAM 303 are mutually connected to each other via a bus 304. An input/output interface 310 is also connected to the bus 304.

Connected to the input/output interface 310 are: an input unit 311 realized by means of components such as a keyboard and mouse; an output unit 312 realized by means of a display, such as an LCD (Liquid Crystal Display) or OEL (Organic Electro Luminescence) display, as well as one or more speakers; a memory unit 313 realized by means of a hard disk or similar component; and a communications unit 314 realized by means of a modem or similar component. The communications unit 314 conducts communication processing with the optical disc playback device 101 via the network 102.

In addition, a drive may also be connected to the input/output interface 310 as appropriate, whereby a removable medium 321 such as a magnetic disk, optical disc, magneto-optical disk, or semiconductor memory can be suitably loaded thereinto such that a computer program read from the removable medium 321 is installed to the memory unit 313 as appropriate.

In the case where the series of processes executed on the server 131 to be hereinafter described are realized by means of software, the one or more programs constituting such software may be installed over a network or from a recording medium.

Such a recording medium may be separate from the main body of the server 131 and realized by means of a removable medium 321 distributed in order provide programs to one or more users, as shown by way of example in FIG. 4. In this case, the removable medium 321 may be a magnetic disk (such as a flexible disk), an optical disc (such as a CD-ROM (Compact Disc Read-Only Memory) or DVD (Digital Versatile Disc)), a magneto-optical disk (such as an MD (MiniDisc)), or semiconductor memory upon which one or more programs have been recorded. However, the above recording medium may also be distributed to users after having been incorporated into the main body of the server 131 in advance, and may be realized by means of the ROM 302 or the hard disk included in the memory unit 313 upon which one or more programs have been recorded.

In addition, a content database 316 is also connected to the input/output interface 310. Information such as programs and data are registered in the content database 316 in advance and in association with the respective performance levels of devices upon which such programs and data are executed. In other words, like the new game 141 for performance level A and the new game 142 for performance level B described earlier, respective programs and data are registered in association with a particular performance level sufficient to adequately execute that program or data without problems, wherein a particular performance level is associated with a specific program or data according to the load (i.e., the amount of processing) induced upon execution of that program or data. Acting in response to a request from the optical disc playback device 101, the CPU 301 selects a suitable program or data from the content database 316, and then supplies that program or data to the optical disc playback device 101 via the communications unit 314.

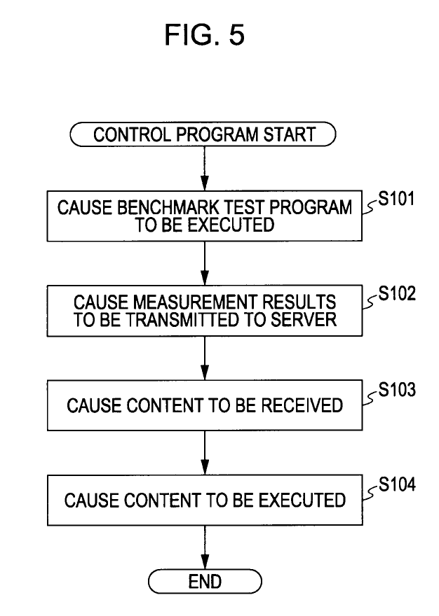

Next, the details of the control program 221 for the BD-J title that is stored on the optical disc 111 and subsequently read and then executed by the optical disc playback device 101 will be described with reference to the flowchart in FIG. 5. Having been read by the optical disc playback device 101, the control program 221 is then executed by the controller 201.

In step S101, the control program 221 causes the optical disc playback device 101 (more specifically, the controller 201) to execute the benchmark test program 222. The benchmark test program 222 may be read from the optical disc 111 at this point, or the benchmark test program 222 may be read together with the control program 221 or other data in advance and then stored in the memory unit 205.

The benchmark test program 222 may be any type of benchmarking program, so long as the program is able to measure the sufficient performance of the optical disc playback device 101 for execution of a BD-J title. Program features, such as the particular measurements to be made and the measurement methods therefor, are arbitrary. Various aspects of performance related to the execution of additional programs may be subject to measurement, such as Java™ Graphics rendering performance, floating-point and vector computations, communication performance, and network bandwidth, for example.

Upon obtaining such measurement results, the control program 221 then causes the optical disc playback device 101 (more specifically, the transmitter 211) to transmit the measurement results to the server 131 in step S102. At this point, the measurement results may be the actual test results from the benchmark test, or an evaluation result (such as a performance level, for example) that is based on those test results. A performance level is thus a scaled expression of the performance of a particular device, wherein the level is determined by evaluating the test results of the benchmark test on the basis of a given standard. For example, given the measurement results 121 shown in FIG. 2, the performance level of the optical disc playback device 101 is determined to be “B”, which is lower than “A”. Such a value may also be transmitted to the server 131 by the optical disc playback device 101 as the measurement result if the server 131 is configured to accept such values. In such a case, the amount of data that is typically sent can be reduced compared to the case wherein the test results themselves are transmitted. Moreover, the performance decision processing conducted on the server 131 (i.e., the selection of which additional program to provide) is also simplified. However, the above case assumes that the server 131 is capable of recognizing such values (i.e., performance levels).

After causing the measurement results to be transmitted, the control program 221 subsequently causes the optical disc playback device 101 (more specifically, the receiver 212) to receive the content that is provided by the server 131 as the additional program, and then causes the received content to be stored in the memory unit 205 (step S103). In step S104, the control program 221 causes the optical disc playback device 101 (more specifically, the controller 201) to execute the above content (i.e., the program or data).

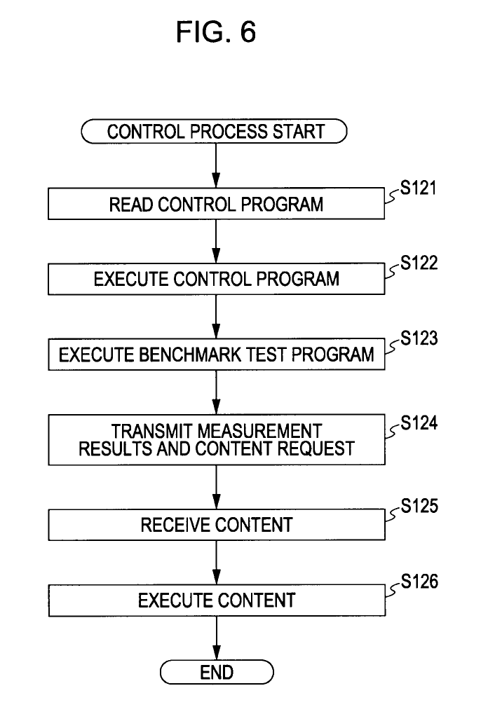

An exemplary control process flow for executing the control program 221 as described above will now be described with reference to the flowchart shown in FIG. 6.

The present control process is initiated when, for example, the optical disc 111 is set to a specific position, and may be initiated by automatically reading the optical disc 111 or by receiving instructions from the user. Once the control process is initiated, the controller 201 first reads the control program 221 from the optical disc 111 in step S121. In step S122, the controller 201 executes the control program 221.

Following the control program 221, the controller 201 reads and executes the benchmark test program 222 in step S123, thereby measuring the performance of the optical disc playback device 101. In step S124, the transmitter 211, also following the control program 221, transmits the measurement results acquired by the controller 201 together with a content request (i.e., a request for an additional program) to the server 131 via the network 102.

Following the control program 221, in step S125 the receiver 212 receives the content supplied by the server 131 in response to the request, and then causes the received content to be stored in the memory unit 205. In step S126, the controller 201 follows the control program to read and execute the content (i.e., the program or data) according to set timings. The content acting as the additional program herein may include, for example, audio and video data, a game program, or a control program.

For example, in the case of audio and video data, the controller 201 may read the data and then perform various processes thereon, such as compositing the data with other data. The controller 201 may then supply the processed data to the playback processor 204 to cause playback immediately or at set timings. For example, the controller 201 may time the playback of the above data such that playback follows continuously after other content data has been first read from the optical disc 111 and played back.

As another example, in the case of a game program or control program, the controller 201 may read and execute the program, thereby conducting processing for the display of game content or performing various controls.

When the processing of the additional program (i.e., the content) as described above is terminated, the controller 201 terminates the control process.

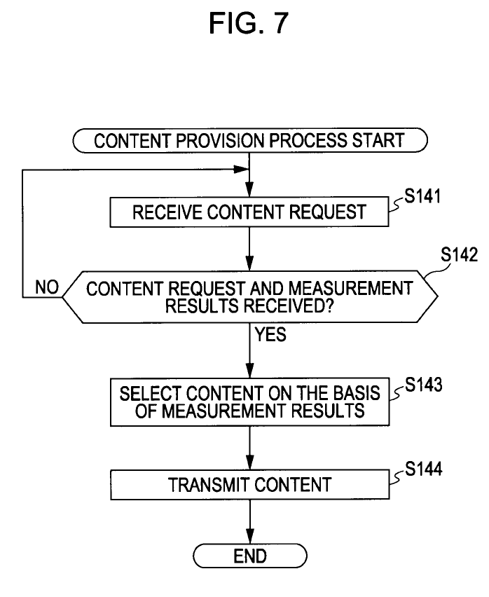

An exemplary process flow for the provision of content by a server 131 operating in response to an optical disc playback device 101 that requests content as described above will now be described with reference to the flowchart shown in FIG. 7.

Upon initiation of the present content provision process, the CPU 301 of the server 131 first controls the communications unit 314 to receive a content request in step S141. In step S142, the CPU 301 determines whether or not both a content request and measurement results were received. The CPU 301 remains in standby repeating the processing in step S141 until it is determined that both a content request and measurement results have been received. In the case where it is determined in step S142 that both a content request and measurement results have been received, the CPU 301 advances the process to step S143.

In step S143, the CPU 301 selects the content to provide from the content database 316, the selection being based on the acquired content request and measurement results (or in other words, on the performance level of the optical disc playback device 101 that originated the request). More specifically, the CPU 301 selects content that both satisfies the content request and is suited to the performance level of the optical disc playback device 101. For example, the CPU 301 may select content matching that specified in the content request, but wherein the associated amount of processing (i.e., the load upon execution) has been adjusted to match the performance level of the optical disc playback device 101.

After having selected the content, in step S144 the CPU 301 controls the communications unit 314 to transmit the selected content via the network 102 to the optical disc playback device 101 that originated the request. Upon transmission of the content, the CPU 301 terminates the content provision process. The CPU 301 then repeats the execution of the content provision process as described above.

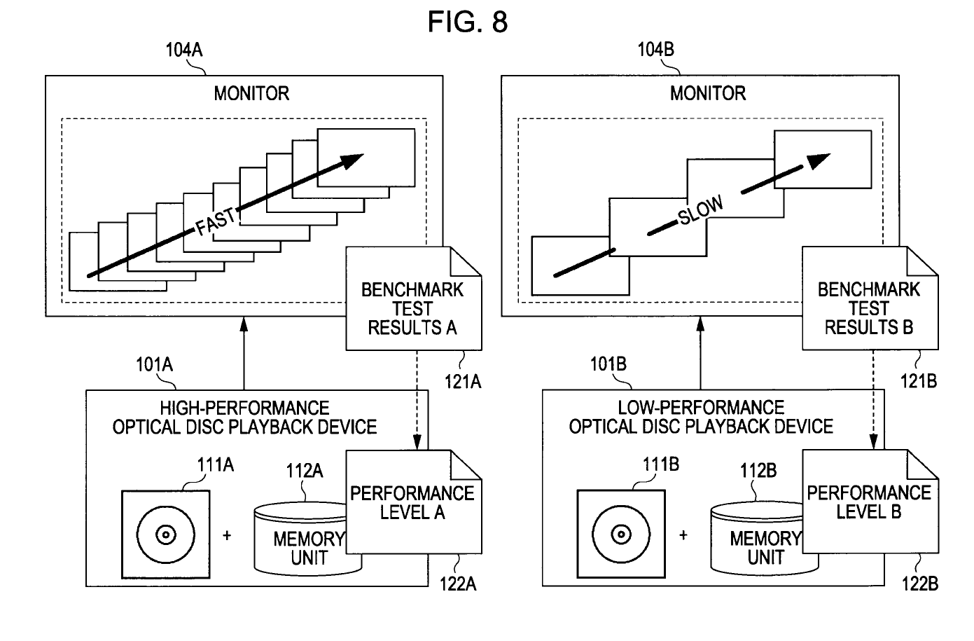

By means of respective processes like those described above, a high-performance optical disc playback device 101A is able to acquire and execute content 122A for performance level A on the basis of benchmark test results 121A that indicate the high performance level A, as shown by way of example on the left side of FIG. 8. As a result, content such as high frame rate video obtained by means of high-speed image processing is displayed without lag on the monitor 104A.

In contrast, given a low-performance optical disc playback device 101B as shown by way of example on the right side of FIG. 8, the respective processes described above may result in content 122B for performance level B to be acquired and executed on the basis of benchmark test results 121B that indicate the low performance level B, for example. As a result, content such as low frame rate video that is processable even with low-speed image processing is displayed without lag on the monitor 104B.

For example, the monitor 104B may display the same video as that displayed on the monitor 104A, but wherein the frame rate has been reduced (i.e., wherein a portion of the frame images have been skipped). Although doing the above results in a reduction in the smoothness of the video motion displayed on the monitor 104B, the amount of processing (i.e., the load) is also reduced, thereby suppressing the occurrence of lag or freezing due to problems such as overflows.

As described above, the control program 221 is able to cause a given device to acquire content 122 having a load that matches the performance level of that device. In so doing, the control program 221 is able to suitably adjust the information processing load according to device performance.

Although the foregoing describes content selection as being conducted on the server 131, the control program 221 (more specifically, the optical disc playback device 101 that executes the control program 221) may, for example, also be configured to select content according to performance. In this case, the processing load associated with content selection on the server 131 can be reduced. Furthermore, such a configuration is also able to accommodate the case wherein the content acquisition site (i.e., the server) differs depending on the content. However, such a configuration also entails an increased load on the optical disc playback device 101, equivalent to that of the content selection processing. Moreover, such a configuration also involves specifying certain content acquisition-related information in advance in the optical disc playback device 101 (or the control program 221), such as information specifying which content is to be selected according to particular performance levels, as well as which servers are able to provide such content.

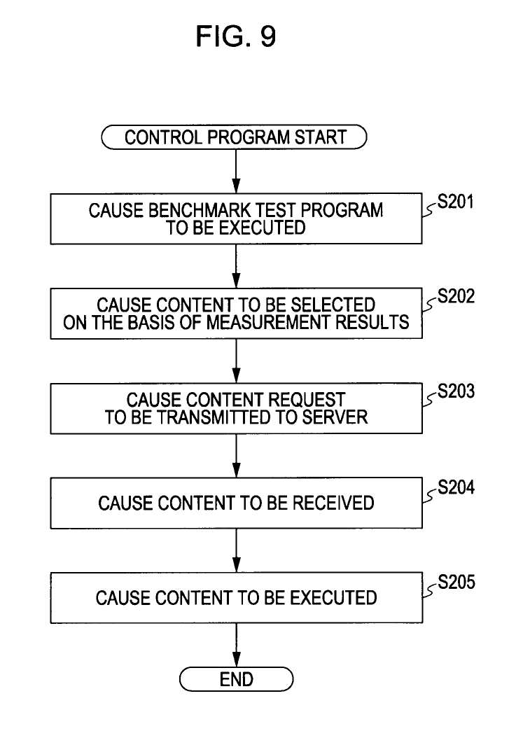

A control program for the above case will now be described in detail and with reference to the flowchart shown in FIG. 9.

In step S201, the control program 221 causes the optical disc playback device 101 (more specifically, the controller 201) to execute the benchmark test program 222, similarly to that of step S101 shown in FIG. 5. Upon obtaining the measurement results, the control program 221 then causes the optical disc playback device 101 (more specifically, the controller 201) to select the content to be requested on the basis of the measurement results, wherein the content to be requested is selected from among candidates prepared in advance (step S202). Once the content to be requested has been determined, the control program 221 causes the optical disc playback device 101 (more specifically, the transmitter 211) to transmit a request for that content to a server (such as the server 131) that provides the respective content (step S203).

Once the content request has been transmitted, the control program 221 subsequently causes the optical disc playback device 101 (more specifically, the receiver 212) to receive content that is supplied from the server 131 (i.e., the content request destination) as an additional program, and then causes the received content to be stored in the memory unit 205 (step S204). In step S205, the control program 221 causes the optical disc playback device 101 (more specifically, the controller 201) to execute the above content (i.e., the program or data).

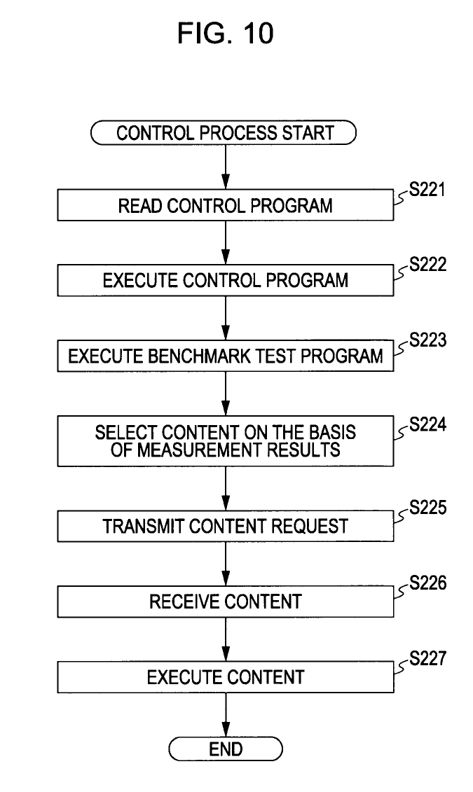

An exemplary control process flow for the above case will now be described with reference to the flowchart shown in FIG. 10.

Upon initiation of the control process, the controller 201 first reads the control program 221 from the optical disc 111 in step S221, similarly to that of step S121 shown in FIG. 6. Upon reading the control program 221, the controller 201 then executes the control program 221 in step S222, similarly to that of step S122 shown in FIG. 6.

Following the control program 221, in step S223 the controller 201 reads and then executes the benchmark test program 222, thereby measuring the performance of the optical disc playback device 101 similarly to that of step S123 shown in FIG. 6. Still following the control program 221, in step S224 the controller 201 selects the content to be requested on the basis of the obtained measurement results, wherein the content to be requested is selected from among candidates prepared in advance. More specifically, the controller 201 selects content whose corresponding amount of processing (i.e., load) has been adjusted to match the performance of the controller 201 itself (and more generally, the optical disc playback device 101).

Upon selection of the content, the transmitter 211 transmits a content request (i.e., an additional program request) acquired from the controller 201 to the server 131 (i.e., a content providing server) via the network 102 (step S225). In the case where the address of the content providing server differs depending on the content, the transmitter 211 transmits a request to the address of the server that provides the selected content.

Following the control program 221, the receiver 212 then receives the content supplied in response to the request, and causes the received content to be stored in the memory unit 205 in step S226, similarly to that of step S125 shown in FIG. 6. In step S227, the controller 201 follows the control program 221 to read and execute the content (i.e., the program or data) according to set timings, similarly to that of step S126 shown in FIG. 6.

When the processing of the additional program (i.e., the content) as described above is terminated, the controller 201 terminates the control process.

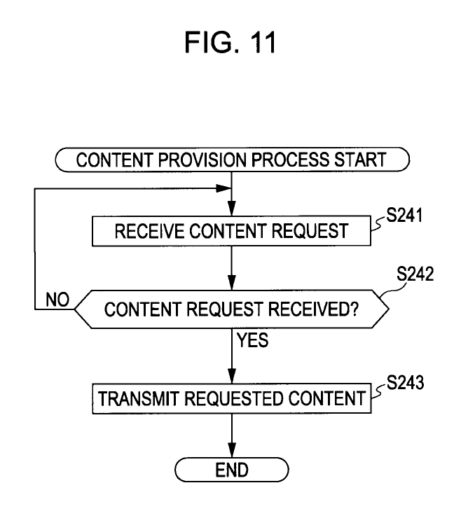

An exemplary process flow for the provision of content by the server 131 in the above case will now be described with reference to the flowchart shown in FIG. 11.

Upon initiation of the present content provision process, the CPU 301 of the server 131 first controls the communications unit 314 to receive a content request in step S241. In step S242, the CPU 301 determines whether or not a content request has been received. The CPU 301 remains in standby repeating the processing in step S241 until it is determined that a content request has been received. If it is determined in step S242 that a content request has been received, then the CPU 301 advances the process to step S243.

In step S243, the CPU 301 selects, from the content database 316, the content requested by the acquired content request, and then controls the communications unit 314 to transmit the selected content to the optical disc playback device 101 that originated the request. Upon transmission of the content, the CPU 301 terminates the content provision process. The CPU 301 then repeats the execution of the content provision process as described above.

Thus, as described above, an optical disc playback device 101 that requests content is able to select content according to the device's own performance level. More specifically, the control program 221 is able to cause the selection regarding which content is to be acquired for a particular device, such that the information processing load is suitably adjusted to match the performance of that device.

In the foregoing, the benchmark test program 222 is described as being stored on the optical disc 111, and benchmark measurements are described as being conducted when a BD-J title is executed. However, the present invention is not limited to the above. For example, benchmark tests may be conducted before the optical disc playback device 101 is shipped from the manufacturing facility, with the measurement results being stored in advance in the memory unit 205 or similar component of the optical disc playback device 101. The control program 221 may then omit the execution of the benchmark test program 222 and instead read and use the measurement results that have been stored in advance. In this case, the benchmark test processing can be omitted during execution of a BD-J title, and thus processing load can be reduced. However, the above case also involves preparing measurement results for performance unrelated to a particular BD-J title, in order to provide measurement results usable by a greater number of BD-J titles. Consequently, the data size of the measurement results and manufacturing costs may increase. The measurement results may be saved in a compressed form in order to reduce the data size. However, the above might not be applicable in cases where actual performance may differ from that measured in advance due to usage conditions. For example, actual performance may change due to firmware updates, externally-connected equipment, or change over time.

In addition, while the foregoing describes just two performance levels A and B, the number of such levels is arbitrary, and may be three or more. Furthermore, such device evaluation may also include a variety of elements, rather than being simply an overall performance metric that is either high or low. Moreover, the evaluation methods and standards for judgment (i.e., threshold values) are arbitrary.

The benchmark test program 222 may also be acquired in a different manner, such as from another device (i.e., a device other than the optical disc 111) via the network 102, for example.

In addition, although the foregoing describes an optical disc playback device 101 by way of example as the apparatus that executes the control program 221 to which the present invention has been applied, the apparatus herein may be any equipment capable of reading data from the optical disc 111, and may include devices in addition to that described above, such as personal computers, game consoles, and optical disc recording and playback devices, for example.

Furthermore, the storage medium that stores the BD-J title described above (i.e., the control program 221, the benchmark test program 222, and the content data 223) may be a storage medium other than the optical disc ill. More specifically, although the foregoing describes a BD-J title by way of example, the present invention is also applicable to titles (i.e., software packages) other than BD-J titles, as long as such titles acquire and execute programs from other devices in a manner similar to that of the BD-Live function described earlier. Consequently, the present invention can also be applied to media such as non-BD-ROM optical discs, magnetic disks, magneto-optical disks, and flash memory instead of the optical disc 111. Obviously, the device upon which the title (i.e., the control program 221) is executed in the above case is taken to be compatible with the particular type of storage medium to which the present invention has been applied.

It should also be appreciated as obvious that the title to which the present invention has been applied may also be acquired from another device connected via the network 102.

Furthermore, the series of processes described above may be configured to be executed by means of hardware or software. In the case where the series of processes described above are executed by means of software, the one or more programs constituting such software may be installed over a network or from a recording medium.

As shown by way of example in FIGS. 3 and 4, such a recording medium may be separate from the main body of the relevant device and realized by means of an optical disc 111 or a removable medium 321 distributed in order provide programs to one or more users. The removable medium 321 may be a magnetic disk (such as a flexible disk), an optical disc (such as a CD-ROM or DVD), a magneto-optical disk (such as an MD), or semiconductor memory upon which one or more programs have been recorded. However, the above recording medium may also be distributed to users after having been incorporated into the main body of the relevant device in advance, and may be realized by means of a component such as the ROM 302 or the hard disk included in the memory unit 313 upon which one or more programs have been recorded.

In addition, in the present specification, the steps specified by the program recorded onto the recording medium are processed in a time series following the order described in the foregoing. However, it should be appreciated that the steps herein may also be processed in parallel or executed individually without being processed in a time series.

In addition, in the present specification, a system is taken to express the entirety of an apparatus that includes a plurality of devices.

Furthermore, the configurations described as single devices in the foregoing may also be divided and configured as a plurality of devices. Likewise, the configurations described as a plurality of devices in the foregoing may also be integrated and configured as a single device. In addition, further aspects of the configuration other than that described in the foregoing may of course also be added to respective devices. Furthermore, a portion of the configuration of a particular device may also be included in the configuration of another device, as long as the overall configuration and operation of the system is essentially the same.

The present application contains subject matter related to that disclosed in Japanese Priority Patent Application JP 2008-087605 filed in the Japan Patent Office on Mar. 28, 2008, the entire content of which is hereby incorporated by reference.

It should be understood that embodiments of the present invention are not limited to the embodiments described in the foregoing, and that various modifications are possible without departing from the spirit and scope of the present invention.

What is claimed is:

1. An information processing apparatus, comprising:
measuring means configured to measure the performance of the information processing apparatus;
transmitting means configured to transmit measurement results in the form of information indicating the performance measured by the measuring means, together with a content request requesting desired content, to another information processing apparatus; and
receiving means configured to receive content supplied by the other information processing apparatus according to the content request and selected on the basis of the measurement results.

2. The information processing apparatus according to claim 1, wherein the measuring means is configured to measure apparatus performance by executing a predetermined benchmark test program.

3. The information processing apparatus according to claim 1, further comprising:
control program executing means configured to execute a control program;
wherein
the measuring means is configured to measure apparatus performance by following the control program executed by the control program executing means,
the transmitting means is configured to transmit the measurement results and the content request by following the control program executed by the control program executing means, and
the receiving means is configured to receive the content by following the control program executed by the control program executing means.

4. The information processing apparatus according to claim 3, further comprising:
reading means configured to read the control program from a storage medium;
wherein
the control program is stored on a storage medium that can be removably inserted into the information processing apparatus, and
the control program executing means is configured to execute the control program that has been read from the storage medium by the reading means.

5. The information processing apparatus according to claim 1, further comprising:
content executing means configured to execute content that has been received by the receiving means.

6. The information processing apparatus according to claim 1, further comprising:
content selecting means configured to select content to acquire on the basis of the measurement results obtained as a result of measurement conducted by the measuring means;
wherein
the transmitting means is configured to transmit to the other information processing apparatus a content request requesting the content that has been selected by the content selecting means.

7. An information processing method, comprising the steps of:
measuring the performance of an information processing apparatus;
transmitting measurement results in the form of information indicating the performance measured by the measuring means, together with a content request requesting desired content, to another information processing apparatus; and
receiving content supplied by the other information processing apparatus according to the content request and selected on the basis of the measurement results.

8. A program that causes a computer for processing information to function as:
measuring means configured to measure the performance of the computer;
transmitting means configured to transmit measurement results in the form of information indicating the performance measured by the measuring means, together with a content request requesting desired content, to another computer; and
receiving means configured to receive content supplied by the other computer according to the content request and selected on the basis of the measurement results.

9. A computer-readable recording medium having recorded thereon a program that causes a computer to function as:
measuring means configured to measure the performance of the computer;
transmitting means configured to transmit measurement results in the form of information indicating the performance measured by the measuring means, together with a content request requesting desired content, to another computer; and
receiving means configured to receive content supplied by the other computer according to the content request and selected on the basis of the measurement results.

10. An information processing system whereby a server provides content to an information processing apparatus, the system comprising:
an information processing apparatus; and
a server;
wherein
the information processing apparatus includes
measuring means configured to measure the performance of the information processing apparatus,
first transmitting means configured to transmit measurement results in the form of information indicating the performance measured by the measuring means, together with a content request requesting desired content, to the server, and
first receiving means configured to receive content supplied by the server according to the content request and selected on the basis of the measurement results, and
the server includes
second receiving means configured to receive the content request and the measurement results supplied by the information processing apparatus,
selecting means configured to select content on the basis of the content request and the measurement results received by the second receiving means, whereby the selected content satisfies the request specified in the content request, and in addition, is suitable with respect to the performance of the information processing apparatus, and
second transmitting means configured to transmit the content selected by the selecting means to the information processing apparatus.

11. An information processing apparatus, comprising:
a measuring unit that measures the performance of the information processing apparatus;
a transmitter that transmits measurement results in the form of information indicating the performance measured by the measuring unit, together with a content request requesting desired content, to another information processing apparatus; and
a receiver that receives content supplied by the other information processing apparatus according to the content request and selected on the basis of the measurement results.

12. A program that causes a computer for processing information to function as:
a measuring unit that measures the performance of the computer;
a transmitter that transmits measurement results in the form of information indicating the performance measured by the measuring unit, together with a content request requesting desired content, to another computer; and
a receiver that receives content supplied by the other computer according to the content request and selected on the basis of the measurement results.

13. A computer-readable recording medium having recorded thereon a program that causes a computer to function as:
a measuring unit that measures the performance of the computer;
a transmitter that transmits measurement results in the form of information indicating the performance measured by the measuring unit, together with a content request requesting desired content, to another computer; and
a receiver that receives content supplied by the other computer according to the content request and selected on the basis of the measurement results.

14. An information processing system whereby a server provides content to an information processing apparatus, the system comprising:
an information processing apparatus; and
a server;
wherein
the information processing apparatus includes
a measuring unit that measures the performance of the information processing apparatus,
a first transmitter that transmits measurement results in the form of information indicating the performance measured by the measuring unit, together with a content request requesting desired content, to the server, and
a first receiver that receives content supplied by the server according to the content request and selected on the basis of the measurement results, and
the server includes
a second receiver that receives the content request and the measurement results supplied by the information processing apparatus,
a selecting unit that selects content on the basis of the content request and the measurement results received by the second receiver, whereby the selected content satisfies the request specified in the content request, and in addition, is suitable with respect to the performance of the information processing apparatus, and
a second transmitter that transmits the content selected by the selecting unit to the information processing apparatus.
